(19) United States
(12) Patent Application Publication
(10) Pub. No.: US 2023/0342383 A1
(43) Pub. Date: Oct. 26, 2023

(54) METHOD AND SYSTEM FOR MANAGING WORKFLOWS FOR AUTHORING DATA DOCUMENTS

(71) Applicant: THE REGENTS OF THE UNIVERSITY OF CALIFORNIA, Oakland, CA (US)

(72) Inventor: Haijun Xia, San Diego, CA (US)

(21) Appl. No.: 18/137,899

(22) Filed: Apr. 21, 2023

Related U.S. Application Data
(60) Provisional application No. 63/333,485, filed on Apr. 21, 2022.

(51) Int. Cl. G06F 16/33; G06F 16/36

(52) U.S. Cl. CPC G06F 16/3344; G06F 16/374

(57) ABSTRACT

A method and system for managing workflows receives a text string being typed within a data document and executes a connection engine that performs natural language processing (NLP) to extract words and phrases having keywords corresponding to data operations, parse the text string into nested nodes including sub-phrases of arguments and keywords. The arguments and keywords are assembled into one or more complete data operation which is executed to return matching results from within a dataset as dependent phrase candidates to complete the text string. The writer selects a candidate from the dependent phrase candidates in response to which the connection engine creates a persistent text-data connection between the selected candidate and the dataset. This persistent text-data connection automatically updates the selected candidate when one or more of the dataset, arguments, and keywords are modified.

### RELATED APPLICATIONS

This application claims the benefit of the priority of Provisional Application No. 63/333,485, filed Apr. 21, 2022, which is incorporated herein by reference in its entirety.

### FIELD OF THE INVENTION

The present invention relates to a system and method for treating text-data connections as persistent, interactive, first-class objects. By automatically identifying, establishing, and leveraging text-data connections, the inventive approach enables rich interactions to assist in the authoring of data documents.

### BACKGROUND

Data documents play a central role in recording, presenting, and disseminating data. Such documents employ text, tables, and visualizations to report findings from data analyses and present data-rich narratives and are an indispensable component of every domain that uses data, impacting a wide range of authorship in the fields of scientific research, finance, public health, education, and journalism. As the world becomes increasingly data-driven, there has been a surge in the variety of data documents, e.g., data-rich documents, data-driven articles, and interactive articles, as well as in the research that has sought to support the authoring and consumption experiences of data documents.

Despite the proliferation of applications and systems that are intended to support data analyses, visualization, and communication, authoring data documents remains a laborious task. During a typical workflow, a user will explore their data by performing data analysis operations (e.g., filtering, sorting, creating tables and charts, etc.) to generate insights using data processing tools and then they will synthesize the insights into a document using a word processing application. During this process, the user must switch back and forth between applications to take notes about the insights they discover, retrieve data from data processing tools and enter it into their document, as well as ensure that there is consistency between the data reported in their document and their underlying dataset. As the user’s underlying data is updated, or they iteratively refine, explore, and change their insights, the user is required to re-analyze their data, refine the corresponding tables and charts, and carefully identify and revise any out of date data in their document. This workflow is not only error-prone, but also requires significant manual and cognitive effort.

A key reason that such tedious and ineffective workflows exist is due to the lack of persistent bindings or connections that exist between the text in data documents and the data in datasets. Most commercial applications do not support the creation or maintenance of text-data connections, instead requiring that users maintain these connections in their mind and perform tedious, manual updates to their documents and data. State-of-the-art research systems that have been created to support the authoring of dynamic and interactive data documents all require the use of programming to specify data bindings, thus posing a higher barrier to entry for novice users. In addition, for each data connection, a user will need to write and update source code to specify and maintain any connections, resulting in tedious workflows, especially for data documents that contain a large amount of data.

Significant research in HCI (human-computer interaction) and data visualization has explored how to support the authoring of data-driven content, such as charts, infographics, data-driven comics, videos, and articles. Within this research, bindings were created between the visual components and the underlying data so that the data-driven content could be updated whenever the data changed, and vice versa. This reduced the repetitive effort necessary to manually update content and enabled rich, dynamic interactive experiences.

Research systems that have been developed to assist in the creation of data visualizations. Such systems follow the principles of direct manipulation as alternatives to template-based chart editing methods that lack customizability and programming libraries that require significant expertise and are often cognitively demanding to use. For example, Data Illustrator (a collaboration between University of Maryland, Georgia Tech, and Adobe Systems Inc.), DataInk (H. Xia, et al., CHI ’ 18, Paper No. 223), and Lyra (University of Washington) enable users to directly create a set of visual encodings, which could be applied to all the data points in a dataset to quickly generate data visualizations. Victor proposed a system that captured parameterized drawing steps, which could later be reused to generate an entire visualization (2013, “Drawing Dynamic Visualizations. http://worrydream.com). Charticulator (Microsoft Research) allows authors to interactively specify chart layouts and employed a constraint-based method to realize layouts.

Recent research has extended the concept of data-driven content to other media such as data-driven articles, which include text, charts, interactive equations, simulations, and so on. For example, “Explorable Explanations” by Bret Victor (2011, worrydream.com) provides a type of data-driven article where the numbers and equations reported in the text were bounded to the underlying data and computation models, enabling readers to manipulate the author’s assumptions and see the consequences, i.e., a “reactive document.” Computational notebooks such as the Jupyter Notebook from Project Jupyter and R Markdown from R Studio allowed users to integrate data with text, executable code, and visualizations to reproduce and share explorations. Creating such data-driven content, however, is tedious and time-consuming because, unlike data visualizations where users can easily configure a small set of visual encodings to create and adjust the entire visualization, each binding in a data-driven article often requires specific configurations with the underlying data. As a result, state-of-the-art systems designed to support authoring data-driven articles use programming languages and require users to manually configure each desired data-driven element. For example, Idyll (University of Washington, Interactive Data Lab), a markup language for web-based interactive documents, enables users to bind data or reader events (e.g., page scrolling) to text, visualizations, and other elements in documents, thereby creating an interactive reading experience. Computational notebooks require users to write code to manipulate and bind data to other content, while text is mainly used for explanatory descriptions alongside code to facilitate documentation.

There has also been significant research exploring how text can be leveraged and enhanced to facilitate both content consumption and creation processes. To facilitate data communication and help users efficiently synthesize information distributed across a data document, prior work has explored connecting text with other data representations such as tables and charts to enhance reading experiences. These approaches use a variety of techniques including direct manipulation, mixed-initiative, crowdsourced, and fully automatic methods. In one example, users can specify desired links between text and charts and leverage these text-chart links to adapt content to a range of layouts. In another example, a mixed-initiative interface leverages NLP (natural language processing) techniques to construct interactive references between text and charts. Another approach is an interactive document reading application that utilizes crowdsourced links between text and charts to enable users to easily navigate from text to referred marks in a chart. Recent advances in deep neural networks have also led to a sequence of automatic methods to facilitate the reading of visualizations with text, such as visualization annotation, chart captioning, and chart question answering.

Beyond linking text with different data representations, extensive research in NLP, computer vision, and machine learning has explored the automatic conversion of domain-specific descriptive text into visual content, such as 3D shapes, scenes, infographics, as well as short video clips, to help content creators. Research in HCI has also leveraged the links between text and visual content to assist in the creation process.

Crosspower™, which is disclosed in International Patent Application PCT/US21/55058 (WO 2022/081891, incorporated herein by reference in its entirety) leverages desired correspondences between linguistic structures and graphical structures to enable users to create and manipulate graphical elements, as well as their layouts and animations. While it supports content creation, it does not focus on the unique challenge of authoring data documents.

Recent advances in NLP (natural language processing) have renewed interest in natural language interfaces (NLIs) for data analysis. Compared to traditional data analysis systems, systems with NLIs enable users to interact with data by using questions and commands expressed via natural language rather than via interface actions or domain-specific languages (e.g., SQL), thereby lowering barriers for non-experts to access data. These systems can be roughly divided into two categories: (1) those that support data queries, and (2) those that support the creation of, and interaction with, data visualizations.

Querying data through natural language has been extensively studied in the field of database systems. Many systems from this field adopted a parsing-based strategy with the goal of constructing SQL queries by identifying entities and their relationships in an input query. Recently, machine learning-based methods have been gaining traction due to the success of deep learning. These methods use supervised neural networks to translate a natural language query to SQL. To leverage the best of both methods, some systems have utilized parsing- and learning-based methods as part of a multi-step pipeline.

NLIs for data visualizations can be seen as an extension of NLIs for databases, which enable users to visualize query results and interact with the generated visualizations. For example, a user can type “show me the medals for hockey and skating by country” to generate a visualization of this specific data. A key challenge when generating visualizations based on natural language is to resolve the ambiguities that exist in the query. While several approaches have been developed using NLIs, in general, these systems treat natural language and text as commands, such that there are no persistent connections between the text and the data.

None of the existing approaches have either recognized, or exploited, the observation that the data reported in data documents is naturally embedded with highly descriptive text. These natural embeddings present an opportunity to solve this text-data connection problem in that they may enable systems to infer text-data connections directly from text during the writing process.

Accordingly, the need exists for the derivation of language-oriented data bindings from the latent connections that exist between text and data. A systematic exploration of how language-oriented text-data connections can assist in the authoring of data documents, the general workflow, pain points, and challenges that exist when authoring data documents must be identified. Building upon this foundation, the present invention has been developed to address the challenges that exist with existing approaches that are intended to support the creation of data documents.

### BRIEF SUMMARY

According to embodiments of the inventive system, which referred to as “CrossData″™, latent language-oriented data bindings that exist within highly descriptive text are extracted and reified as persistent, interactive, first-class objects to assist in the authoring of data documents. CrossData™ employs a Connection Engine that automatically detects, establishes, and maintains text-data connections during the writing process through the use of natural language processing (NLP) techniques. The inventive approach enables writers to efficiently retrieve, compute, explore data, and refine tables and charts using interactive techniques enabled by the language-oriented data bindings that are identified and created. CrossData™ leverages these bindings to automatically ensure consistency and congruency between the text, data, tables, and charts. In addition, data documents written with CrossData™ automatically become interactive documents for readers, giving them a dynamic, explorable reading experience.

A technical evaluation of the performance of the CrossData™ Connection Engine in extracting latent text-data connections demonstrated correct construction in 88.8% of 529 text-data connections identified from 206 sentences. To assess the utility of language-oriented data bindings, an expert evaluation demonstrated that CrossData’s interaction techniques are effective in significantly reducing the manual effort required while writing data documents and also enable fluid and enjoyable workflows. Feedback from experts also indicated that language-oriented authoring exposes new possibilities for data exploration and authoring.

The inventive CrossData™ system employs a language-oriented data binding approach that extracts latent text-data connections from written text. Once these connections have been extracted, a set of novel interaction techniques enables writers to efficiently author and iterate on data documents.

In one aspect of the invention, a method for managing workflows for authoring data documents in which one or more dataset is retrieved from a data source includes using a computing device to: receive a text string within a data document being generated by at least one writer; execute a connection engine configured to perform natural language processing (NLP) to: extract from within the text string words and phrases having keywords corresponding to data operations within a predefined operation dictionary; parse the text string into a plurality of nested nodes comprising sub-phrases comprising independent data phrases and keywords; assemble the independent data phrases and data operations in one or more node of the plurality of nested nodes into one or more complete data operation; and execute the one or more complete data operation and return matching results from the one or more dataset as one or more dependent phrase candidate to complete the text string; prompt the at least one writer to select a selected candidate from the one or more dependent phrase candidates; and create a persistent text-data connection between the selected candidate and the one or more dataset; wherein the persistent text-data connection is configured to automatically update the selected candidate when one or a combination of the one or more dataset, the independent data phrases, and the keywords is modified by the writer. In some embodiments, the data operations include one or a combination of Retrieve Value, Filter, Find Extremum, Compute Derived Value, Determine Range, Find Anomalies, and Compare. The data operations may be arguments including one or more independent data phrases or an output of another data operation. In some embodiments, the one or more dataset comprises a table, where the independent data phrases and the output are a row, a column, or a value in the table. The connection engine may be further configured to update the table to add a new row or a new column in response to computation of a dependent phrase. In some embodiments, the table may be embedded within the data document. The dependent data phrase may be an output of one or more computation by the data operations, where the output is a derived value that does not exist in the dataset. In other embodiments, the one or more dataset may be a chart embedded within the data document. The step of parsing the text string may use a context-free grammar, where a structure of the plurality of nested nodes is independent of a context of the text string. The connection engine may be further configured to generate potential independent phrases within an incomplete text string by performing string matching with all strings in the dataset and synonym matching with all attribute names in the dataset.

In another aspect of the invention a computer system includes a computing device and a memory configured to store program instructions, where, when executed by the computing device, the program instructions cause the computer system to perform one or more operations including: receiving a text string within a data document being generated by at least one writer; executing a connection engine configured to perform natural language processing (NLP) to: extract from within the text string words and phrases having keywords corresponding to data operations within a predefined operation dictionary; parse the text string into a plurality of nested nodes comprising sub-phrases comprising independent data phrases and keywords; assemble the independent data phrases and data operations in one or more node of the plurality of nested nodes into one or more complete data operation; and execute the one or more complete data operation and return matching results from the one or more dataset as one or more dependent phrase candidate to complete the text string; prompt the at least one writer to select a selected candidate from the one or more dependent phrase candidates; and create a persistent text-data connection between the selected candidate and the one or more dataset; wherein the persistent text-data connection is configured to automatically update the selected candidate when one or a combination of the one or more dataset, the independent data phrases, and the keywords is modified by the writer. In some embodiments, the data operations include one or a combination of Retrieve Value, Filter, Find Extremum, Compute Derived Value, Determine Range, Find Anomalies, and Compare. The data operations may be arguments including one or more independent data phrases or an output of another data operation. In some embodiments, the one or more dataset comprises a table, where the independent data phrases and the output are a row, a column, or a value in the table. The connection engine may be further configured to update the table to add a new row or a new column in response to computation of a dependent phrase. In some embodiments, the table may be embedded within the data document. The dependent data phrase may be an output of one or more computation by the data operations, where the output is a derived value that does not exist in the dataset. In other embodiments, the one or more dataset may be a chart embedded within the data document. The step of parsing the text string may use a context-free grammar, where a structure of the plurality of nested nodes is independent of a context of the text string. The connection engine may be further configured to generate potential independent phrases within an incomplete text string by performing string matching with all strings in the dataset and synonym matching with all attribute names in the dataset.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1C illustrate how CrossData™ leverages text-data connections to enable writers to efficiently retrieve (FIG. 1A), compute (FIG. 1B), interactively explore data, and adjust tables and charts (FIG. 1C) during writing processes.

FIG. 2 illustrates connections between text and data through the use of independent data phrases and arguments to create dependent data phrases.

FIG. 3A illustrates an exemplary pipeline to establish text-data connections; FIG. 3B provides a sample flow diagram for establishing text-data connections for use in generating an interactive data document.

FIGS. 4A-4E illustrate sample constituency trees used for inferring data operations and suggesting dependent data phrases in accordance with an embodiment, where FIG. 4A shows parsing of the sentence into a constituency tree, FIG. 4B shows inference of text phrases, FIG. 4C assembles data operations into an output with suggested dependent data phrases; FIG. 4D and FIG. 4E provide examples of correct and incorrect constituency trees, respectively.

FIGS. 5A and 5B illustrate operations for retrieving data and computing values, respectively.

FIGS. 6A-6C provide examples of using placeholders, where FIG. 6A displays a partial sentence with insufficient information to perform a calculation; FIG. 6B shows a placeholder inserted to indicate a computation; and FIG. 6C shows an updated placeholder once more information is provided.

FIG. 7 illustrates an example of fixing misdetections.

FIG. 8 shows an example of automatically maintaining consistency with the data text is changed.

FIG. 9 provides an example of interactive text, where interactions between operation keywords and independent phrases trigger updates in related dependent data phrases.

FIGS. 10A-10C illustrate examples of adjustments of tables (FIG. 10A) and charts (FIGS. 10B-10C) based on the text.

FIG. 11 depicts examples of different Likert-scale user responses following evaluation of an embodiment of the inventive CrossData™ system.

FIG. 12 is a block diagram illustrating an example of a computer system suitable for use in accordance with an embodiment of the present disclosure.

### DETAILED DESCRIPTION OF EMBODIMENTS

As used herein, “document” means a text-containing work of authorship that is generated by a person (a “writer”) using a word processing or writing application. “Document” includes data documents which employ text, tables, and visualizations to report findings from data analyses and present data-rich narratives within the document. The document may be a report, manuscript, thesis, presentation materials, and other text-containing writings. By way of example but not limitation, the documents may be created by programs such as Microsoft® Word®, Microsoft® PowerPoint®, Apple® Pages®, Corel® WordPerfect®, Google® Docs®, and others.

As used herein, “writer” means one or more person who uses a software-based document creation tool to create or generate a document, i.e., a work of authorship. The terms “writer”, “author”, and “user” may be used interchangeably for the person. More than one person may be the writer of a given document in a collaboration. A “writer” may also include a person who is reviewing, editing, and/or revising a document.

The inventive approach identifies and leverages connections that exist between highly descriptive text and data to facilitate creation of data documents. Instead of requiring users to manually specify data-driven bindings using programming languages, the CrossData™ system infers and recommends connections that implicitly exist between text and data to the user during the writing process. These bindings, when coupled with a set of novel interaction techniques, enable users to easily select and update text-data connections. The CrossData™ system not only significantly reduces the manual effort needed to create data documents - it simultaneously enables an interactive reading experience for readers without any additional effort.

Perhaps the most closely related work to the inventive approach is Crosspower™, disclosed in International Patent Application PCT/US21/55058 (International Publication No. WO 2022/081891), which is incorporated herein by reference. Crosspower™ leverages desired correspondences between linguistic structures and graphical structures to allow users to flexibly and quickly create and manipulate graphical elements, as well as their layouts and animations. While the inventive CrossData™ scheme also supports content creation, it focuses on the domain of data documents, which involves a different set of interaction techniques to coherently address challenges that are often encountered when authoring data documents.

The inventive CrossData™ approach is based upon natural language processing (NLP) techniques but differs significantly from prior art NLP-based approaches. Highly descriptive text is viewed as another representation of the underlying data, so it is important to preserve the connections that exist between the text and data. These persistent connections are then leveraged to provide rich interactions that can be used during the writing process.

To better understand the general workflow, pain points, and best practices involved in creating data documents, a formative interview study was conducted. Eight professionals from various domains, including business services, e-commerce, accounting, banking, biomedical science, retail, and internet services were interviewed (four female, aged 27 - 30). Each participant had three to seven years’ experience working in their current role. Their responsibilities included exploring, analyzing, and reporting data. Interviews were conducted remotely using videotelephony and lasted between 45 to 60 minutes.

During the interviews, the participants were asked to describe a recent memorable experience while writing data documents, common pain points, and how they resolved the situation. They were also asked to share their documents and tools through screen sharing, if possible. The interview ended with a questionnaire to collect demographic information. Four pilot interviews with another four professionals were conducted beforehand to develop the study protocol.

Interviews were audio-recorded, transcribed, and analyzed using a reflexive thematic analysis. The codes and themes were generated both inductively (i.e., bottom-up) and deductively (i.e., top-down), focusing on the workflow breakdowns, repetitive operations, and workarounds that occurred while writing data documents.

The general process of producing data documents involved data exploration and writing. During the exploration stage, participants cleaned, processed, and explored their data with a concrete goal or question assigned to them by their supervisor. Microsoft® Excel®, the widely-available spreadsheet, was the most common data tool used for this process. All participants said that when insights and findings were discovered within the data, they would “create or screenshot the table or chart (of the insights), insert it to a Microsoft® Word® document, and write a short description for it”. After accumulating enough insights, participants moved to the writing stage. All participants indicated that they frequently revisited the data during the writing process, as their original insights could be unclear, complicated, incorrect, obsolete, or unappealing to present. The document would often be reviewed, edited, and/or modified by collaborators, leading to additional data exploration. Thus, the writing processes were highly intermixed with data exploration. Finally, the document would be carefully reviewed alongside the data to ensure that there were no inconsistencies between the document and data before the final version was delivered.

During the process of generating the data documents, participants needed to retrieve data from the data analysis applications (e.g., Excel®) to incorporate into the authoring, i.e., word processing, applications they were using (e.g., Word®). All participants reported that the need for “frequent application switching and navigation to the data” led to significant problems within the retrieval process. For example, with Excel®, participants needed to first identify the correct datasheet, and then navigate within the sheet to locate the data they wanted to access. Participants would often use the “search” or “find” function to accelerate their navigation, which required them to remember specific data properties and navigation pathways when multiple matches were found. Once data was located, participants needed to transfer it to a text editor. While participants frequently relied on copy-and-paste operations to avoid transcription errors, they often needed to change the data format. For example, the process may involve converting large absolute values to abbreviated forms or performing simple calculations such as a ratio of change. This typically forced them to manually type the data into the document after performing the conversion or calculation which could require opening a third application to perform the calculation. Each of these steps was tedious and often had to be repeated several times during authoring, resulting in time-consuming and error-prone workflows.

To create an accurate finished document, it is of critical importance to ensure consistency between the document and its underlying data. Erroneous data reporting can insert delays into the finalization of an important document due to the need for additional review and revisions of the document by others. It can lead to negative performance evaluations for the person originally assigned to handle the project, and in a worst case scenario, inaccurate data can cause financial and reputational losses for a company. Professionals reported that the inconsistencies were usually caused by data updates. For example, one participant, a marketing manager, often started to draft a document before all data became available in order to meet deadlines. This required them to update their analysis and document as soon as new data became available. Another participant who worked in a financial services company frequently was required to update her documents when there were adjustments in model parameters. Whenever the underlying data was updated, all participants reported that they needed to “read through [their] documents carefully and fix the inconsistent content manually”, which was “inefficient and prone to error”. One commenter noted that the IT team in his company developed a plugin that synchronized the data between Excel® and Word® automatically, however, it required the user to manually connect cells in the spreadsheet to text in the document. Another commenter mentioned that a professional review team in her company would proofread her documents to highlight any inconsistencies. Overall, these methods were considered to be cumbersome, expensive, and time-consuming.

Participants reported that exploring different ways to present data was a common but time-consuming task. They needed to perform additional data exploration during the writing stage, because “only when I write down the data in the document, I know what’s the best way to present it”. One participant who worked as an operating officer in an IT company reported that she frequently needed to switch growth period data covered by presentations between yearly, quarterly, and monthly.

Exploring alternative data presentations was reported as being time-consuming, because participants often needed to repeat their analysis steps, create new tables and charts, and update the relevant text with new data. One commenter mentioned she always used tables or charts to show evidence for the insights reported in the text: “if I want to report a new metric, I will add one more column to the table.” Another commenter noted that to “add one more sentence” to introduce “the ratio of a group of users to all users”, he needed to go back to Excel®, perform multiple operations to re-create tables and charts, and then insert them into the document.

Participants reported that during the writing stage, they frequently had to go through multiple iterations on the presentation of data. Even the smallest changes could initiate significant ripple effects to the data reported in the text, as well as the corresponding tables and charts. With such significant overhead, participants and their collaborators had to iterate on the document offline when iterations were suggested in real-time, requiring additional meetings and discussions, thus hindering their collaborative process.

In summary, the formative study found that professionals encountered numerous issues during the process of writing data documents with mainstream tools and that they were forced to address these issues manually. They struggled while inputting the data into their documents, maintaining the consistency between their documents and data, and handling the numerous interconnected components during iterations. The findings indicate that the key reason for their tedious and ineffective workflows was the lack of connection between the text in data documents and the data in datasets. The solution is, thus, to create connections that could be maintained with minimal effort by the users.

When using text to describe data from a dataset in a document, a user establishes an abstract connection between the text and the data elements in their mind. A key insight from the formative study was that current tools require the user to mentally maintain these connections, leading to tedious, repetitive, and error-prone operations. The inventive solution is to reify these connections as persistent, first-class objects and leverage them to address the issues that occur during the writing process. To this end, two steps were undertaken: Step 1) a Connection Engine was developed to automatically establish and maintain these connections during writing processes, and Step 2) a set of interactions was designed based on these connections to tackle the issues identified in the formative study. The implementation presented in the following description focuses on tabular data, which is one of the more common data formats. Application of the inventive CrossData™ approach to other data formats will become apparent to those of skill in the art based upon this example.

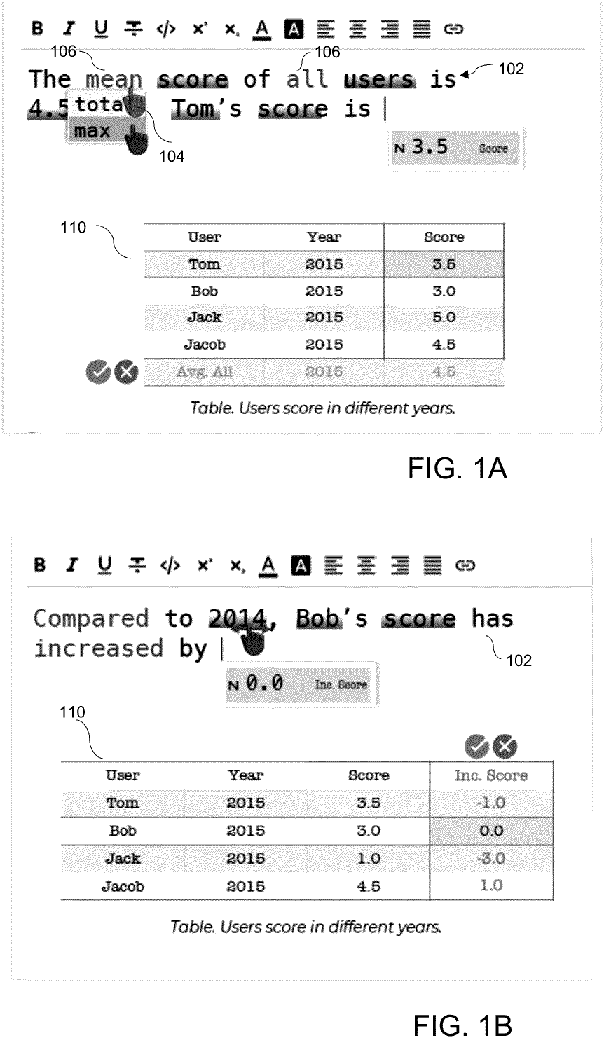

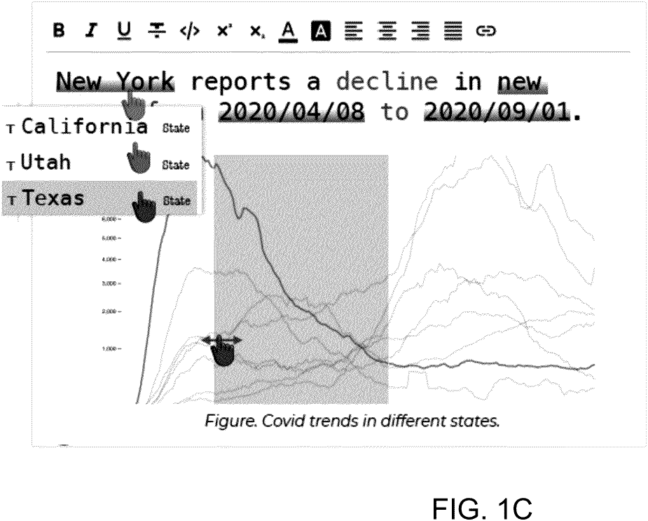

FIGS. 1A-1C provide a brief overview of the CrossData™ approach, which is described in more detail below. Each figure represents a simulated screenshot within a writing application such as Microsoft® Word®. The text 102 that is in the process of being typed in the upper part of the image includes keywords 106 which, when the user hovers over the keywords with the pointer 104, leverages text-data connections to enable users to efficiently retrieve (FIG. 1A) data from the associated table 110 in the data analysis application, compute (FIG. 1B), interactively explore data and adjust tables and charts (FIG. 1C),during their writing processes, while also automatically maintaining data consistency between their text, data, tables, and charts.

In step 1 of the CrossData™ process, the Connection Engine establishes text-data connections. Given the text in a data document and an underlying dataset, the goal is to infer, establish, and maintain connections between the text in the document and the corresponding data in the data analysis application, e.g., Excel® worksheet or similar.

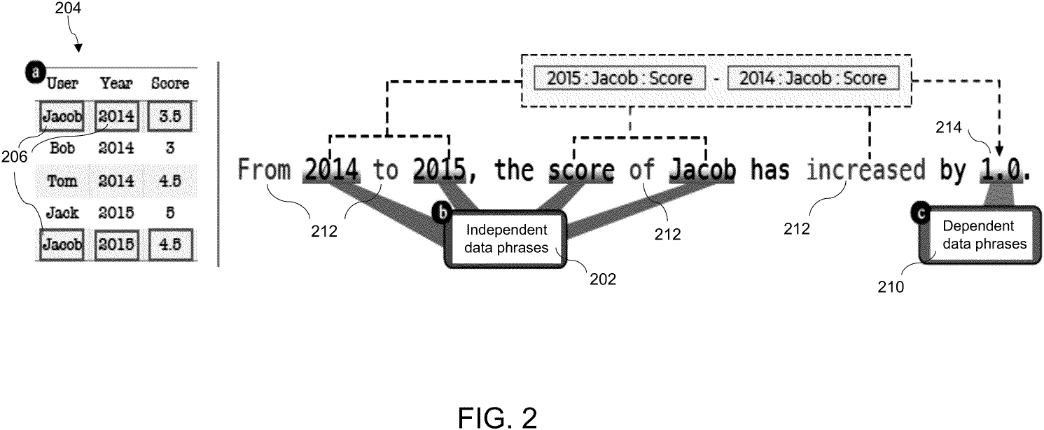

Referring to FIG. 2, when describing data using text, the phrases in text can connect with the underlying data in two ways:

Independent data phrases 202 directly report items (rows), attributes (columns), and values (cells) in the dataset. For example, in FIG. 2, the terms “2014”, “2015”, “score”, and “Jacob” (item (b)) (highlighted in turquoise), are independent data phrases connected to the respective corresponding cells 206 in table 204 (item (a)). Independent data phrases can be used as arguments to compute dependent data phrases 210.

Dependent data phrases 210 (item (c)) present the output of data operations that take other data phrases as arguments. A dependent data phrase can report data in the dataset or derived values that do not exist in the dataset. For example, the last term “1.0” (214) is calculated based on the other phrases and connects to the data dependently. The data operations to compute a dependent data phrase are described by keywords 212 (in blue text) such as “from”, “to”, “of”, and “increased”.

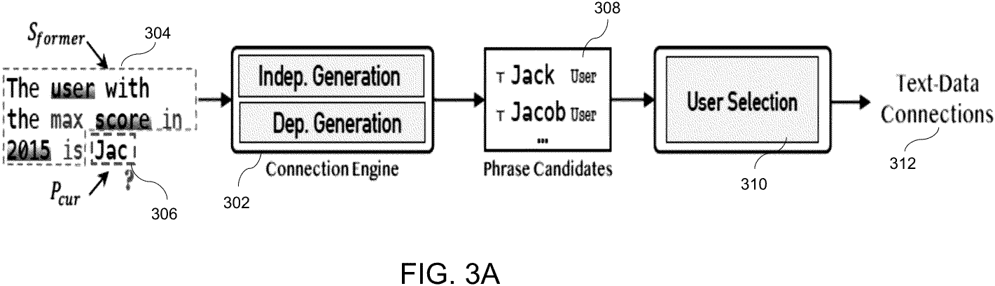

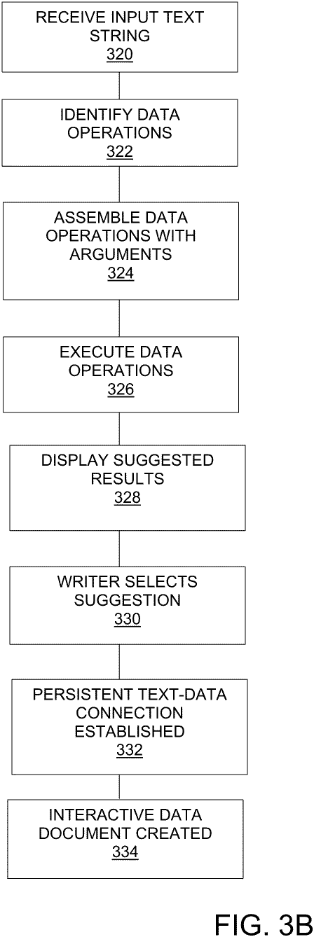

Referring to FIG. 3A, the Connection Engine 302 helps users establish and maintain connections during the writing process. Suppose that after writing the first half of a sentence (S_{former}) 304 (within the orange dashed lines), the author begins typing a new word or phrase (P_{cur}) 306 (within the turquoise dashed lines). Connection Engine 302 generates all potential connections for P_{cur}, which are presented as a list of data phrases 308 (“Phrase Candidates”) to the user. Once a data phrase is chosen by the author in step 310, the Connection Engine 302 inserts the phrase into the document with the text-data connection 312 and all relevant meta information is maintained.

To establish connections for independent data phrases, Connection Engine 302 generates potential independent phrases for P_{cur} 306 by performing string matching of P_{cur} with all strings in the dataset and synonym matching with all attribute names in the dataset. The synonym matching is achieved by calculating the similarity of the word embeddings provided by spaCy, an open-source industrial-strength NLP toolkit with built-in support for trainable pipeline components such as named entity recognition, part-of-speech tagging, dependency parsing, text classification, entity linking, and more. (spaCy is published under the MIT License.) All matches will then be returned as suggestions, ordered by their matching scores. When the writer selects a suggestion, an independent phrase will be inserted and create a connection between the independent phrase and the underlying dataset. For example, if the writer selects “Jack” as their choice for “user”, the dataset for Jack will be connected.

Since dependent data phrases are the result of data operations that take other phrases as arguments, Connection Engine 302 takes three steps to identify, assemble, and execute the data operations, and then returns the results of the data operations as suggestions to the writer. Selection of a suggestion by the writer will insert a dependent data phrase and establish a connection with the underlying data operation. FIG. 3B provides a flow diagram of the key steps of the process according to an exemplary embodiment, which are initiated upon input of text by the writer (Step 320) :

1. (Step 322) Identifying data operations: To detect data operations, Connection Engine 302 matches words and phrases with keywords within a predefined operation dictionary. The dictionary is derived from Amar et al.’s work (“Low-level Components of Analytic Activity in Information Visualization”, in Proc. of InfoVis. IEEE, 2005, pp.111-117, incorporated herein by reference) which summarizes ten low-level analytical operations for data analysis. Table 1 below lists the ten operations defined by Amar et al.:

TABLE 1

| | |
|---|---|
| Operation | Operation |
| Retrieve Value | Determine Range |
| Filter | Characterize Distribution |
| Compute Derived Value | Find Anomalies |
| Find Extremum | Cluster |
| Sort | Correlate |

The summarization by Amar et al. has been widely used in NLI systems to extract desired data operations from users’ input queries. An operation takes a few arguments as input and outputs either an item (row), an attribute (column), a value (cell), or a derived value of the underlying dataset. Table 2 lists the arguments, outputs, and keywords for seven operations implemented in the prototype system.

TABLE 2

| | | | |
|---|---|---|---|
| Operation | Arguments | Output | Kevwords |
| Retrieve Value | row, column | value | be, report, at, from, rise, drop, increase, decrease, decline, fail, compare with, etc. |
| Filter | value, column (optional, default as the value’s column] | rows | after, before, since, in, until, more, high, over, higher, greater, larger, bigger, under, less, lower, lesser, smaller, between, etc. |
| Find Extremum | rows, column (optional, default as all) | value | rank, max, maximum, highest, greatest, largest, biggest, most, min, minimum, smallest, lowest, least, heaviest, lightest, best, worst, etc. |
| Compute Derived Value | rows, column | value | median, average, mean, sum, total, etc. |
| Determine Range | rows, column | value | range, extent, from... to..., etc. |
| Find Anomalies | rows, column | value | outlier, except, apart from, etc. |
| Compare | row1, row2, column | value | compare, down, different from, etc. |

In the examples illustrated in the figures, keywords are shown with blue letters. In the example shown in FIG. 2, the keywords are “from”, “to”, “of′, and “increased” for a combination of Filter, Retrieve Value, and Compare operations. In the example shown in FIG. 3, the words “max”, “in” and “is” are keywords indicating a combination of Filter and Find Extremum operations. The arguments, which are the terms/phrases highlighted in turquoise, are “user”, “score” and “2015”.

2. (Step 324) Assembling data operations with arguments: As an operation needs arguments to compute output, the arguments of an operation can either be independent data phrases or the output of other operations. To infer the arguments for each operation, we parse the input text as a constituency tree using the Berkeley Neural Parser through its integration with spaCy. (N. Kitaev, et al., “Multilingual Constituency Parsing with Self-Attention and Pre-Training”, In Proc. of ACL. ACM, 2019, pp.3499-3505, incorporated herein by reference.). The Berkeley Neural Parser annotates a sentence with its syntactic structure by decomposing it into nested sub-phrases. Within a constituency tree, each node represents a text phrase in the sentence (e.g., noun phrase (“NP”), verb phrase (“VP”), and prepositional phrase (“PP”), with smaller phrases being deeper in the tree, i.e., the leaf nodes are words. Therefore, Connection Engine 302 uses a bottom-up order to recursively examine whether the independent data phrases and operations in a node can be assembled as a complete data operation, as well as whether data operations should be assembled as compounded data operations. Connection Engine 302 employs a rule-based method to achieve the examination, as explored in earlier NLI research. Specifically, Connection Engine 302 matches the set of phrases and their grammatic relationships (also provided by spaCy) of a node with pre-constructed rules, each of which describes the necessary arguments for a data operation and the required data types (i.e., item, attribute, or value) for the arguments.

3. (Step 326) Executing data operations: Finally, Connection Engine 302 executes the data operation in the root node of the sentence to obtain the result. Since a keyword may match different operations, Connection Engine 302 employs a greedy strategy to enumerate all possible matched operations for a keyword, assemble them into complete operations. In Step 328, the engine returns all the results as dependent phrase candidates for the writer who, in Step 330, selects the appropriate or desired suggestion(s). In Step 332, the writer’s selection of a suggestion creates a persistent text-data connection between the document that is being created and the data record that supports the text within the document to which it relates, thus creating an interactive document (Step 334).

The pseudocode for assembling data operations to compute dependent phrases is provided below:

Input: The root node of the constituency tree of S_{former}
Output: The operation to compute the dependent phrases
1 Function InferDepPhrase (node):
// The leaf node represents a word in the sentence.
// Return it if it is an operation or data phrase.
2 if node is leaf then
3 if node is operation then
4 return node, None
5 if node is data phrase then
6 return None, node
7 return None, None
8
// Collect the output from its child nodes.
9 Ops = { }
10 DPs = {}
11 foreach chìld _node in node do
12 child_Ops, child_DPs = InterDepPhrase(child_node)
13 Ops = Ops ∪ child_ Ops
14 DPs = DPs ∪ child_DPs
15
// Assemble incomplete operations with arguments.
16 complete)_Ops = { }
17 foreach incomplete_Op in Ops do
// See whether the incomplete operation and other operations
// or data phrases can be assembled as a complete one.
18 argument_Ops, argument_DPs = CanAssembleWith(incomplete_Op, Ops \ /incomplete_Opl,DPs)
// If can, assemble them and update the variables.
19 if argument_Ops or argument_DPs is not None then
20 Ops = Ops \ {argument_Ops U {incomplete_Op})
21 DPs = DPs \ argument_DPs
22 complete_Ops = complete_Ops U Assemble(incomplete_Op, argument_Ops,argument_DPs)
23
24 Ops = Ops U complete_Ops
25 if node is the root then
26 return Ops
27 else
28 return Ops, DPs

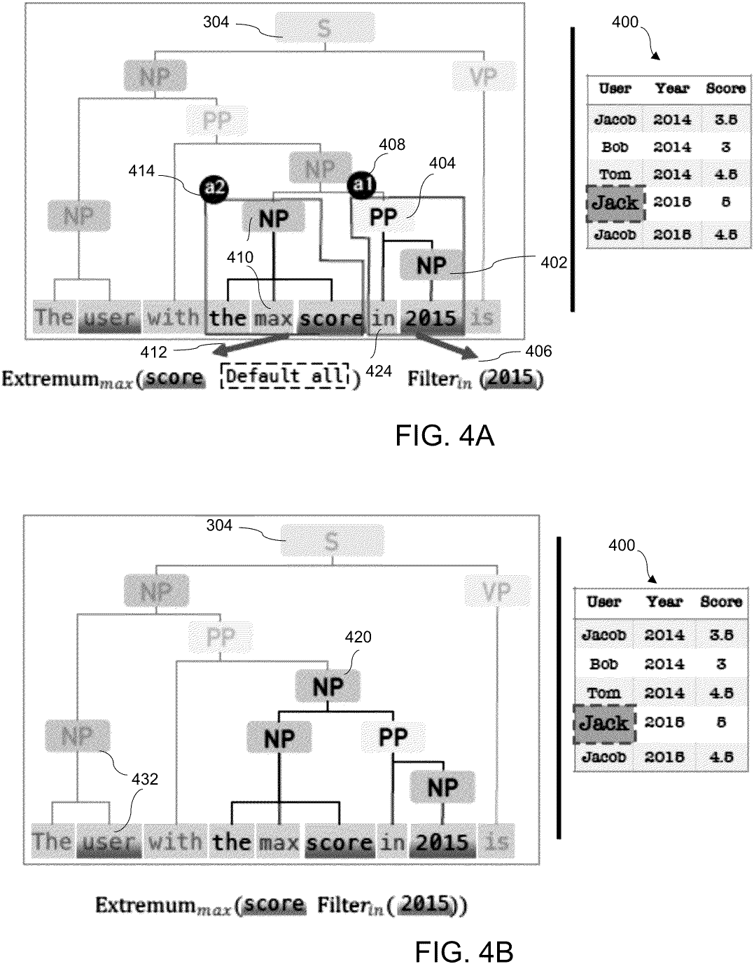

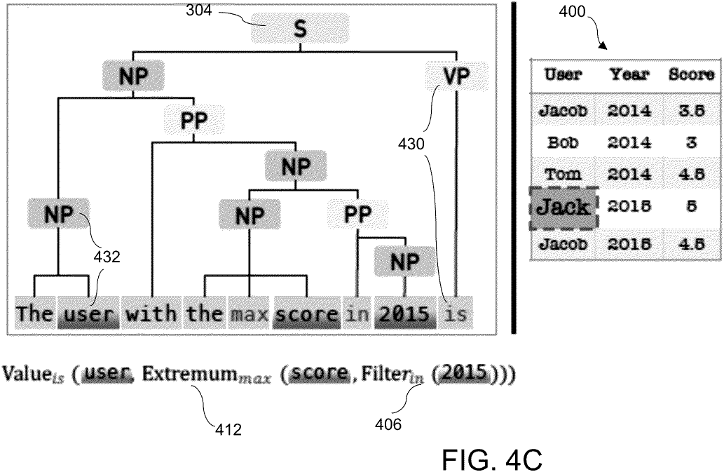

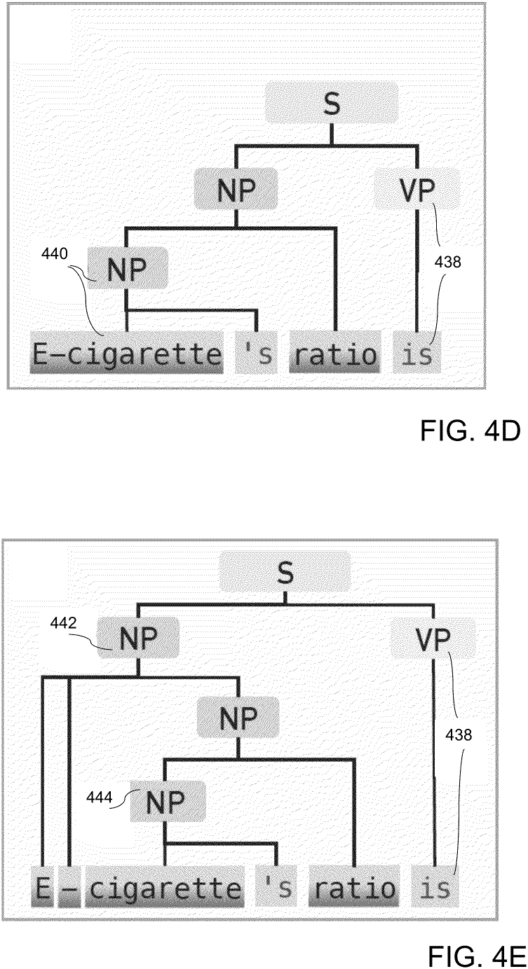

Referring to FIGS. 4A - 4C, and using the sample sentence 304, “The user with the max score in 2015 is”, the sentence is parsed into a constituency tree of nested sub-phrases and Connection Engine 302 starts the inferring process from the leaf node “2015” (402), which reports a value in the data. As shown in FIG. 4A, since “2015” (402) is an independent phrase and the only one at the lowest level, no data operations can be inferred. Connection Engine 302 then recursively processes the parent nodes of “2015” (node 402) to a prepositional phrase (PP) node 404 and infers a filter operation 406 for the keyword “in” 424 with “2015” as the argument (item (a1) 408). Similarly, Connection Engine 302 infers a find extremum operation 412 for the keyword “max” 410 on the “Score” column in table 400 from the phrase “the max score” (item (a2) 414). According to predefined rules, the operation finds the extremum in all rows of table 400 by default. In FIG. 4B, when proceeding to its parent node 420, the engine fills the default argument (i.e., all rows) with the output of the filter operation 406 (“in 2015”) since its output is a list of rows in table 400. In FIG. 4C, the engine 302 recursively repeats this process and finally infers a retrieve value operation in the root node from the keyword “is” (node 430), whose arguments are the phrase “user” (node 432) and output of the find extremum operation. As such, the dependent data phrase is computed from a compounded operation of the filter 406, find extremum 412, and retrieve value 430 operations. The output of this compound operation, “Jack”, will then be recommended to the user. Once the user selects “Jack” from the suggestions, a dependent phrase will be inserted, and a text-data connection will be established.

Parsing the sentence as a constituency tree is a core step to generate dependent phrase candidates. However, a review of constituency trees for successful cases revealed that even if the constituency trees were parsed from incomplete sentences or parsed incorrectly, the connection engine could still output the correct candidates.

First, the constituency parsing is built based on a context-free grammar, which means the tree structure parsed from a segment of text is not dependent on its context. Thus, even if the sentence is incomplete, the engine can still leverage the constituency tree, the local structure of which will not change when new text is appended.

Second, the connection engine is sufficiently robust to handle incorrect constituency tree as it leverages: 1) existing independent data phrases selected by the user, and 2) redundant information in the constituency tree. For example, FIG. 4D shows the expected constituency tree of “E-cigarette’s ratio is”, with which the connection engine will infer a filter operation (keyword “is”, node 438) with “E-cigarette” as the argument node 440. However, spaCy may parse the sentence as an incorrect constituency tree (FIG. 4E), by separating “E”, “-”, and “cigarette” into different nodes 442 and 444. Nevertheless, the connection engine will not use “cigarette” as the argument for the filter operation in node 444, since “E-cigarette”, which is selected by the writer, is maintained as an independent phrase. Instead, the connection will recursively process to node 442 and use “E-cigarette” as the argument for the filter operation to output the correct result.

Each operation needs arguments to compute the output. The arguments of an operation can either be independent data phrases or the output of other operations. (See, e.g., Table 2.) In the present embodiment using data in tabular format, the types of independent data phrases and output of operations can be row, column, or value. An incomplete operation will be assembled with the data phrases that match its argument types. The actual implementation of the operation detection and assembling was partially inspired from NL4DV, the natural language toolkit for data visualization available from the Georgia Institute of Technology. NL4DV is a Python package that takes as input a tabular dataset and a natural language query about that dataset. In response, the toolkit returns an analytic specification modeled as a JSON object containing data attributes, analytic tasks, and a list of Vega-Lite specifications relevant to the input query.

CrossData™ leverages the text-data connections found by the Connection Engine to provide novel interactions that address the issues identified in the formative study, thus enabling users to efficiently retrieve, compute, explore data, and adjust tables and charts during the writing of data documents, while automatically maintaining data consistency between the text, data, tables, and charts.

Connections for Inputting Data: The formative study found that data retrieval is tedious and must be repeated several times when authoring data documents. Professionals manually retrieved data from data analysis tools (e.g., Excel®), leading to issues while application switching, navigating data, and transferring data into writing tools (e.g., Microsoft® Word®). To address these issues, several interactions that enable users to leverage the output of the Connection Engine were thus designed.

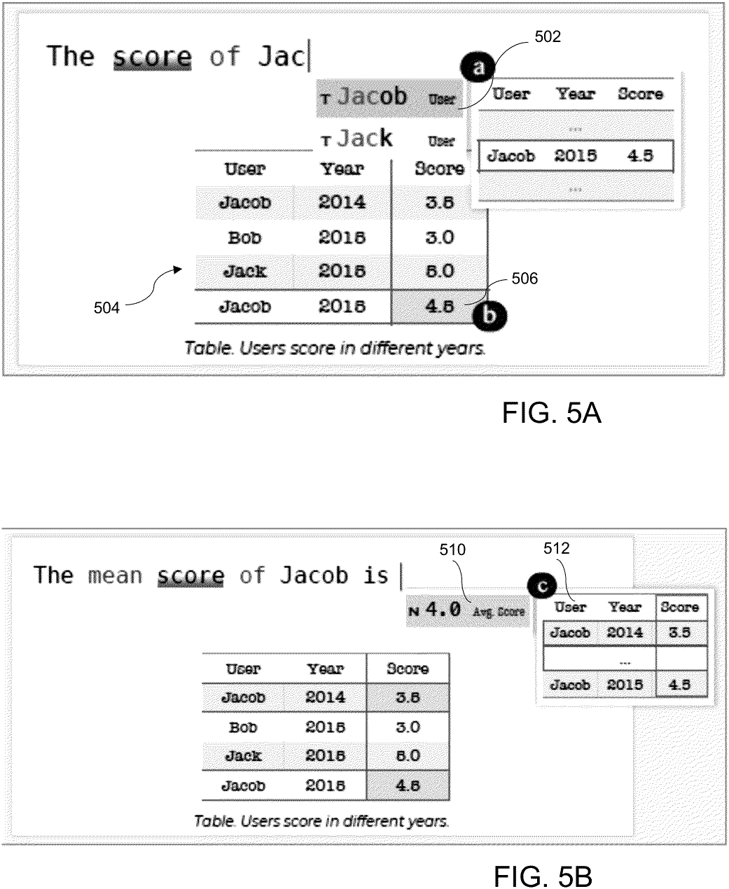

Retrieving Data: As a user types in the text editor, CrossData™ automatically runs the Connection Engine 302 to detect the connections. Referring to FIG. 5A, the underlying data elements that the text potentially connects to are returned as suggestions for the writer in list 502 (item (a)). In this example, the typing of the first few letters, i.e., “Jac”, prompts a list with two options, “Jacob” or “Jack”. Additional information (e.g., the data types, the context in the worksheet, etc.) about each suggestion is provided for each list item to help the user select the correct data and resolve ambiguities. If the underlying data table is also visible on the user interface, as shown in the illustrated example, CrossData™ automatically highlights within the table 504 the corresponding row, column, or cell based on the data phrases the writer is typing. In this case, row 506 is highlighted (item (b)). Such reference highlighting can help writers efficiently locate the elements in tables. The writer can select a suggestion from the list to insert it into the text editor or simply enter the text following the suggestion. CrossData™ will automatically maintain the connection between the text and data for later reuse.

Computing Values: Occasionally, the user needs to compute and input values that do not exist in the dataset. CrossData™ detects these dependent connections and calculates their derived value using the Connection Engine 302. As shown in FIG. 5B, the derived value, in this example, the “Avg. Score” 510 (highlighted by the orange background), and the detailed information about the calculation are displayed as suggestions 512 (item (c)). The user can select and insert the derived data while preserving the connection. The mean score is computed and suggested as a dependent data phrase for the user. Detail information about each suggestion is provided in table 512 to assist in resolving ambiguities.

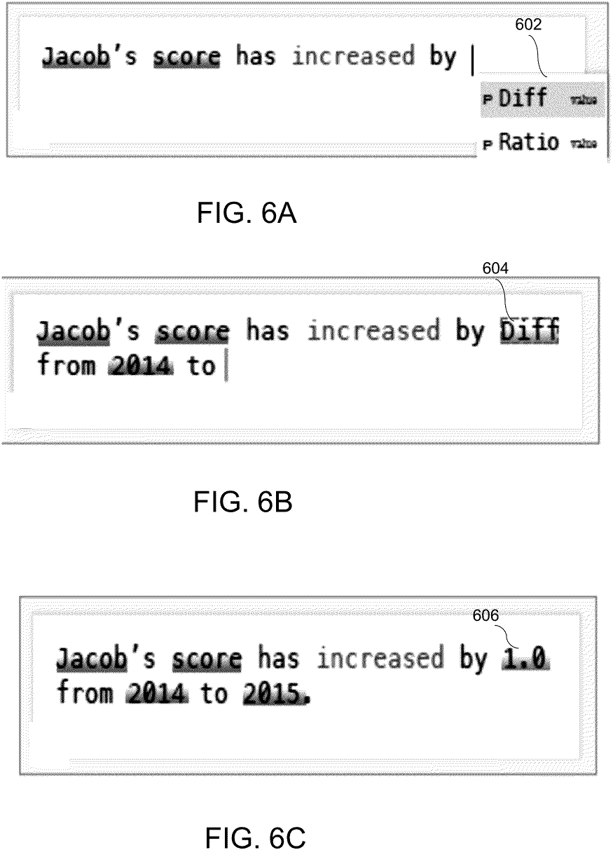

Using Placeholders: An issue when retrieving or computing data in a written sentence, which differs from command-like sentences in other NLIs systems, is that the data that one may want to retrieve or compute could be input before its dependency is retrieved or computed. CrossData™ thus provides a set of placeholders, such as “Diff” (difference), “Ratio”, and “Count”, which the writer can employ to indicate expected data types. For example, in FIG. 6A, if the writer wants to report an increase in Jacob’s score while the year range is unknown, the writer can press the “Tab” key to open a suggestion list 602 to select and insert a placeholder 604, shown in FIG. 6B. Then, whenever new data phrases in the sentence are inserted or detected, the Connection Engine 302 will attempt to evaluate and update the placeholders 606 with the desired information, in this case, the numerical value of the difference, in this case, “1.0”. (FIG. 6C). All placeholders are thus dependent data phrases.

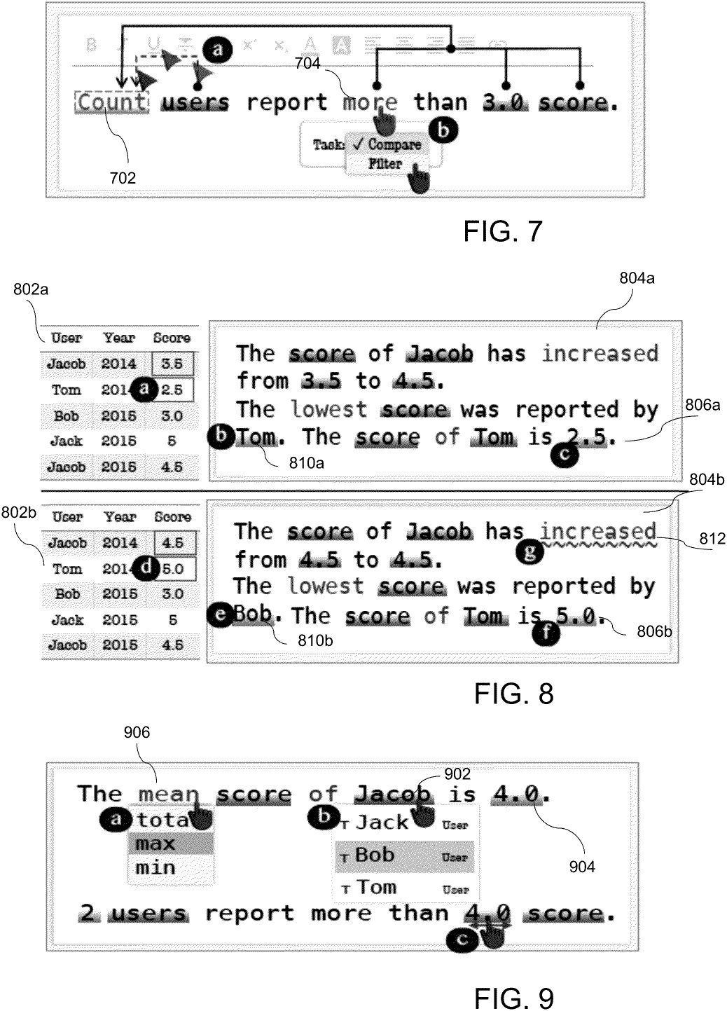

Fixing Misdetections: In some situations, it is possible that CrossData™ may retrieve or calculate incorrect data for dependent data phrases. The incorrectness might be the result of mis-detected dependencies (i.e., wrong input) or operation keywords (i.e., wrong tasks). Referring to FIG. 7, CrossData™ allows the user to interactively correct these misdetections by hovering with the pointer over a dependent data phrase 702 (the term “Count”, indicated here by orange text) to visualize and modify its dependencies (item (a)) or by hovering the pointer over operation keywords 704, in this case “more”, to refine their tasks (item (b)). In this example, hovering over “more” offers the writer the selection of a “compare” operation or a “filter” operation.

Connections to Maintain Consistency: The formative interviews demonstrated that most of the professionals manually maintained consistency between their text and data and considered this process to be time-consuming and error-prone. With the help of preserved connections, CrossData™ can update data phrases and highlight problematic operation keywords to help users maintain consistency.

Data-driven Updates: Whenever a data element within the underlying dataset is updated, CrossData™ automatically updates all independent and dependent phrases that connect to the data element. In the example shown in FIG. 8, if the writer (or other person responsible for data entry/updates) changes the score of Tom from “2.5” in table 802a (item (a)) to “5.0” in table 802b (item (d)), in the document text 804b, CrossData™ will update Tom’s score from “2.5” (806a, item (c)) to “5.0” (806b, item (f)) in the third sentence and the name in the second sentence will be changed from “Tom” (810a, item (b)) to “Bob” (810b, item e)) to reflect the fact that Bob’s and not Tom’s reported score is now the lowest.

Operation Keywords Checker: Inconsistencies can also occur between the operation keywords and the data. For example, when changing the score of the first row in table 802a from “3.5” (item (a)) to 4.5 in table 802b (item (d)), the operation keyword “increase” is inconsistent with the data. However, different from data phrases, updating operations can be challenging because operation phrases are usually text descriptions. In such cases, CrossData™ may highlight the problematic operation keyword 812 to alert the writer. In the illustrated example, a red wavy underline (item (g)) is shown.

When iterating on a data document, writers frequently change various elements in their document. While the interaction techniques introduced above can alleviate the overhead of retrieving values and maintaining consistency during iteration, a pressing and unaddressed challenge is the cascading effects that occur when changes are made to text, tables, and charts.

The inventive CrossData™ approach addresses this challenge by reifying text-data connections as interactive objects, which enable users to manipulate them to iterate on data documents and explore new insights directly in a document. Because the data phrases, tables, and charts are all connected with the underlying data, the necessary changes can be automatically performed without additional user effort.

Interacting with Data-Driven Text: Text phrases that are connected with underlying data can be interactively manipulated. Independent phrases represent an item (row), attribute (column), or value (cell) within the spreadsheet. Referring to FIG. 9, CrossData™ allows the writer to interactively change an independent phrase to other items, attributes, or values. As illustrated, by hovering the pointer over item 902 - “Jacob” (item (b)), the writer is given the option of selecting the name of a different user, i.e., “Jack”, “Bob”, or “Tom”, to replace “Jacob”. Changes to interactive text phrases are automatically propagated to other phrases according to the inferred data operation. Selection of a different name will interactively change the dependent phrase value 904 to match the score of the selected user. For example, if the writer interactively changes “Jacob” to “Bob”, the correlation engine of CrossData™ will update the value 4.0 to Bob’s mean score. The interactions provided by an independent phrase depend on its data type, e.g., quantitative, nominal, or ordinal. To avoid meaningless changes, CrossData™ limits changes of item phrases to other items, attribute phrases to other attributes that have the same data type, and value phrases to other values in the same column.

Writers often need to iterate on the metrics they use to report on their data, such as changing the average value to the median value or from a daily basis to a weekly basis. CrossData™ allows writers to interactively alter operation keywords to achieve such goals. For example, by hovering the pointer over keyword 906 (item (a)), the writer can click and change the “mean” to another computation such as “total”, “maximum”, or “median”. The available operation keyword alternatives may be predefined within a curated dictionary. (See, e.g., Table 2.)

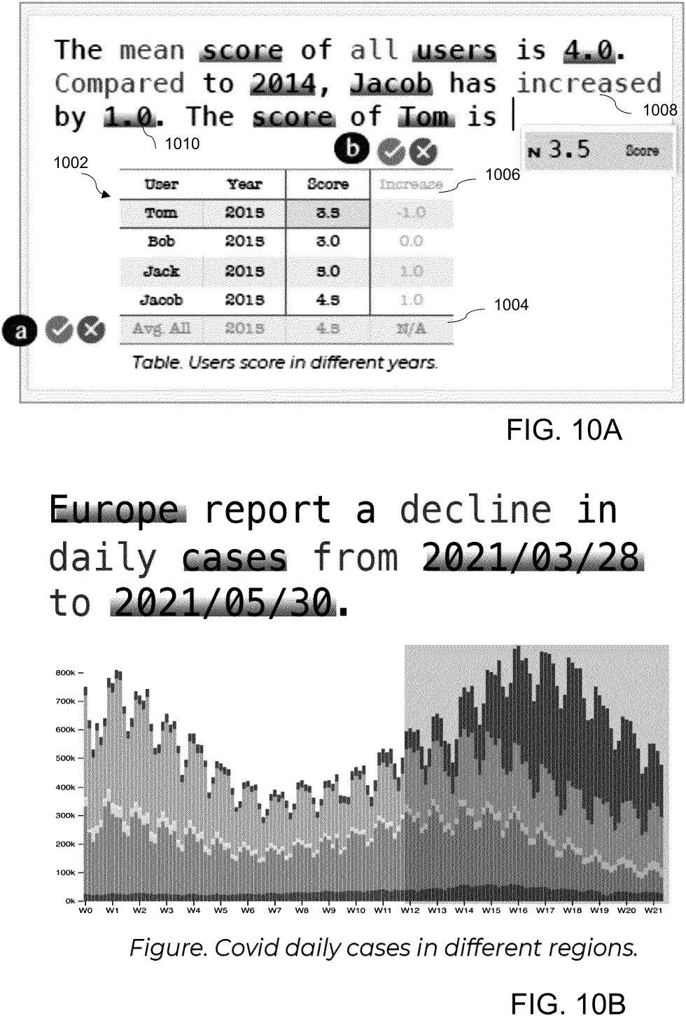

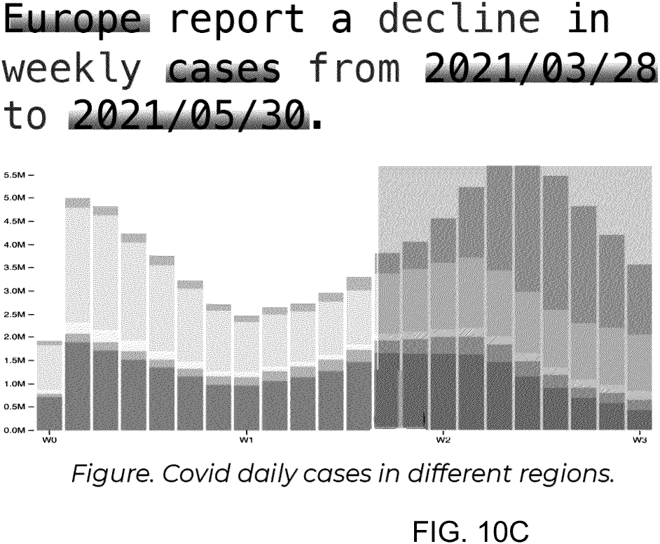

Automatic Adjustments of Tables and Charts: Because the text, tables, and charts embedded in a document are all connected to their underlying data, CrossData™ automatically updates tables and charts with the text to ensure the textual descriptions and data visualizations are consistent. Referring to FIG. 10A, CrossData™ supports three types of language-oriented manipulations of embedded data tables, based on the detected data operations in the text. First, when a dependent phrase is the output of a sort or find extremum task, CrossData™ will sort the table 1002 based on the column involved in the task. Second, if the user computes a dependent phrase by aggregating multiple rows (e.g., summation), CrossData™ automatically adds a new row 1004 that shows the aggregation results (item (a)). Third, if, based on the indicated operation keyword 1008, the dependent phrase 1010 computes a new attribute for an item (e.g., the increase from last year), CrossData™ will attempt to calculate this attribute for all rows and add a new column 1006 to table 1002 (item (b)). Changes to the tables suggested by CrossData™, i.e., the added rows and/or columns, can be accepted or rejected by clicking on the check mark or “x”, respectively.

Similarly, embedded charts may also be synchronized with textual descriptions. CrossData™ automatically updates the charts if different data properties are reported in the text. For example, when the writer switches the reporting of new infection cases from daily, as shown in FIG. 10B, to weekly in FIG. 10C, CrossData™ will automatically switch the underlying data source of the chart to synchronize with the change. CrossData™ will also automatically annotate the time period of the charts based on the dates reported in the text. Since both the text and chart are connected to the underlying data, the user can directly manipulate the chart to adjust the text (e.g., dragging the chart overlay (shaded portion) in FIG. 10C, or vice versa, which can facilitate better authoring and reading experiences.

Connection Engine Evaluation: The effectiveness of the CrossData™ approach depends on whether the Connection Engine can suggest the correct data phrases to the user. A technical evaluation was conducted to assess the accuracy and robustness of the Connection Engine.

Methodology: The goal of the evaluation is to assess whether the Connection Engine can suggest the correct data phrases based on the text in the writing process. Because independent data phrases are suggested based on string matching, which is usually highly accurate, we focused on evaluating the generation of dependent data phrases. Specifically, we gathered a corpus of sentences together with their corresponding datasets. For each sentence, we manually labelled all independent data phrases with the connections to the datasets as part of the input and all dependent data phrases as ground truth. We then input each sentence word by word into the Connection Engine to simulate a realistic writing experience and compared the suggested dependent phrases against the ground truth. The experiment was run on an Apple® Macbook® Pro with a i7 2.2 GHz Intel® CPU.

Dataset: We collected sentences from 10 data documents from reputable public sources that cover multiple domains, such as World Health Organization, Bureau of Labor Statistics, Pew Research Center, National Center for Education Statistics, National Institutes of Health, California Department of Public Health, and a private company, as well as their corresponding datasets. We sampled the sentences by: 1) manually filtering all sentences that reported data in the documents, and 2) randomly sampling no more than 30 sentences from each document. For each sentence, we manually labeled the independent and dependent phrases. In total, the corpus contained 206 sentences (5398 words), with 807 independent phrases and 529 dependent phrases.

Metrics: We measured the ratio of correct dependent data phrases recommended by the Connection Engine to the total number of dependent data phrases. When the engine returned multiple candidates for a dependent phrase, we counted it as correct if the top 5 candidates contained the correct one. We also measured the time to compute the candidates.

Results: The accuracy of the dependent phrases was 88.8% (i.e., 470 corrects), which demonstrates the robustness and accuracy of the Connection Engine. Among these correct cases, the majority were computed by the compounded operation of filtering and retrieving values (i.e., 262 cases, 55.7%), the finding extreme operations (i.e., 62 cases, 13.2%), the compounded operation of finding extreme operations and retrieving values (i.e., 61 cases, 13.0%), and the compounded operation of finding extreme operations and comparing values (i.e., 48 cases, 10.2%). This echoes the findings from the formative study discussed above, reflecting that the data retrieval operation was prevalent in real world data documents. The average time to generate candidates was 0.3 seconds, which was sufficient for interactive use cases and could be further optimized with better implementations.

We further investigated the failure cases and identified three major reasons for these failures. Note that a failure may be caused by multiple factors.

Error Type 1: Lack of Context (i.e., 50.8% of cases): Among the failure cases, most cases (i.e., 31) failed because certain expressions, e.g., “it”, “these”, “previous years”, referred to other data phrases. For example, with the sentence “These three countries comprised 89% of all cases reported in the region”, to compute the “89%”, the Connection Engine needed to know which countries “These three countries” referred to. In this example, the three countries were mentioned in previous sentences as independent phrases. This problem, however, can be addressed by employing co-reference resolution, i.e., finding expressions that refer to the same entity within or between sentences, which has been advanced in recent years. The Connection Engine can integrate co-reference resolutions models to connect data phrases in previous sentences to the present one, thereby maintaining the context to infer text-data connections. (See, e.g., K. Lee, et al., “End-to-end Neural Coreference Resolution”, In Proc. of ACL. ACL, 2017, pp. 188-197, incorporated herein by reference.)

Error Type 2: Expect Textual instead of Numerical Outputs (i.e., 27.9% of cases): Seventeen cases failed because the expected output was a text description rather than a number. For example, in “Two in five e-cigarette users reported usually paying for their own e-cigarettes”, the expected output was “Two in five” while the engine returned “43%”. To address this issue, the Connection Engine could generate more candidates with different formats, or adopt more advance generative language models, such as GPT-3, described by T.B. Brown, et al., in “Language Models are Few-Shot Learners” . In Proc. of 34^{th} Conf. on Neural Information Processing Systems (NeurIPS 2020), incorporated herein by reference. Note that while the data formats of the suggested phrases do not match the ground truth, the underlying data operations inferred by the Connection Engine were correct. This means that the Connection Engine could accurately infer 91.9% of all data operations.

Error Type 3: Uncovered Operations (i.e., 21.3% of cases): Thirteen cases failed because the required data operations in the sentences were not covered by the 10 low-level data operations summarized by Amar et al. In the example “Cases have decreased steeply for the past four weeks”, computing the “four weeks” is a high-level analytical task (i.e., given a column and a text description of the trend, report the range of rows that fulfill the trend), which was not supported by the prototype system used in the evaluation. Considering the rule-based nature of the Connection Engine, these cases can be addressed by extending the predefined operation dictionary and corresponding rules.

To summarize, the performance evaluation showed that the Connection Engine was robust enough to achieve a high accuracy when generating dependent phrases about a set of real-world sentences collected from multiple domains. The in-depth analysis indicated that most of the failure cases could be corrected by extensions to the prototype engine used in the evaluation.

The CrossData™ system was developed as a technology tool to exploit the notion of language-oriented data bindings. It was recognized that the system might initially create usability problems for writers who are familiar with existing tools. To gain feedback about the effectiveness of our approach without being bogged down by the initial challenges some writers may encounter with usability, we conducted an expert evaluation study that focused on collecting experts’ feedback about the usefulness of each interaction technique and how language-oriented authoring could facilitate the overall workflow of authoring data documents.

Participants and Apparatus: Eight participants were recruited to participate in the study (E1 - E8, 5 female, age 28 - 31). The group included 1 auditor (accounting), 1 operation officer (internet services), 1 investment banking associate (financial services), 1 due diligence consultant (business services), 2 marketing managers (internet services and retail) and 2 researchers (data science and public healthy). E1-E5 participated in the formative study. All participants had more than 5 years of experience analyzing data and writing data documents as part of their daily work. The most used data processing and writing tools included Microsoft® Excel®, Google® Sheets®, Microsoft® Word®, Google® Docs®, and Tableau® (Tableau Software, LLC). The study was conducted remotely with CrossData™ implemented as a responsive Web application that participants could directly access from their personal computers. Video conferencing was used to communicate with participants, share screens, and record the study. Participants received $60 (USD) for the approximately 90-minute session.

Each evaluation session included four phases:

Introduction and Training (30 mins): The experimenter first introduced the study protocol, research motivation, and concepts of CrossData™. Then, the experimenter walked the participants through the system with an example that contained two datasets that were presented as a table and a bar chart, and five insights to report. Participants were encouraged to ask questions anytime during the process. Participants were then asked to replicate the example to become familiar with the system.

Reproduction Task (15 mins): Participants were asked to reproduce a given data document, which presented a USA COVID-19 dataset with a multiple line chart and six sentences, each of which reported an insight. The original datasets, a multiple line chart, and a choropleth map were provided as the context for the insights.

Creation Task (20 mins): Participants were asked to write a short document to report on three datasets about Global COVID-19 cases. Each dataset included one data representation (i.e., a chart or a table) and three insights. The short document needed to contain at least one insight from each dataset, and one data representation. To simulate realistic iterative processes, after the participants finished the document, the experimenter asked them to iterate on the document by 1) reporting two more insights, 2) inserting one more chart or table, and 3) changing the data phrases or operators in the documents. The changes to the data phrases or operators were selected to ensure that the participants experienced all of the proposed interaction techniques.

Semi-structured Interview and Questionnaire (25 mins): After the creation task, participants completed a questionnaire that probed the usefulness and usability of the techniques using a 5-point Likert scale (i.e., 1 - Strongly Disagree, 5 - Strongly Agree). Then, the experimenter conducted a semi-structured interview to further collect feedback about the utility of each interaction technique, CrossData™’s effectiveness in supporting realistic workflows, limitations of the proposed techniques, and potential improvements.

Results: All participants successfully finished the reproduction and creation tasks. On average, each participant wrote 12.6 sentences and 123.3 words, which contained 22.1 independent and 13.6 dependent data phrases. All participants experienced all the proposed interaction techniques.

The following discusses how the proposed interactions: 1) addressed the issues identified in the formative study: 2) could improve participants’ current authoring workflows; and 3) could be extended for data exploration and to enable new workflows that bridge the gap between the writing and data exploration stages. Also discussed are We also report on observed behaviors that suggested future improvements for real-world usage.

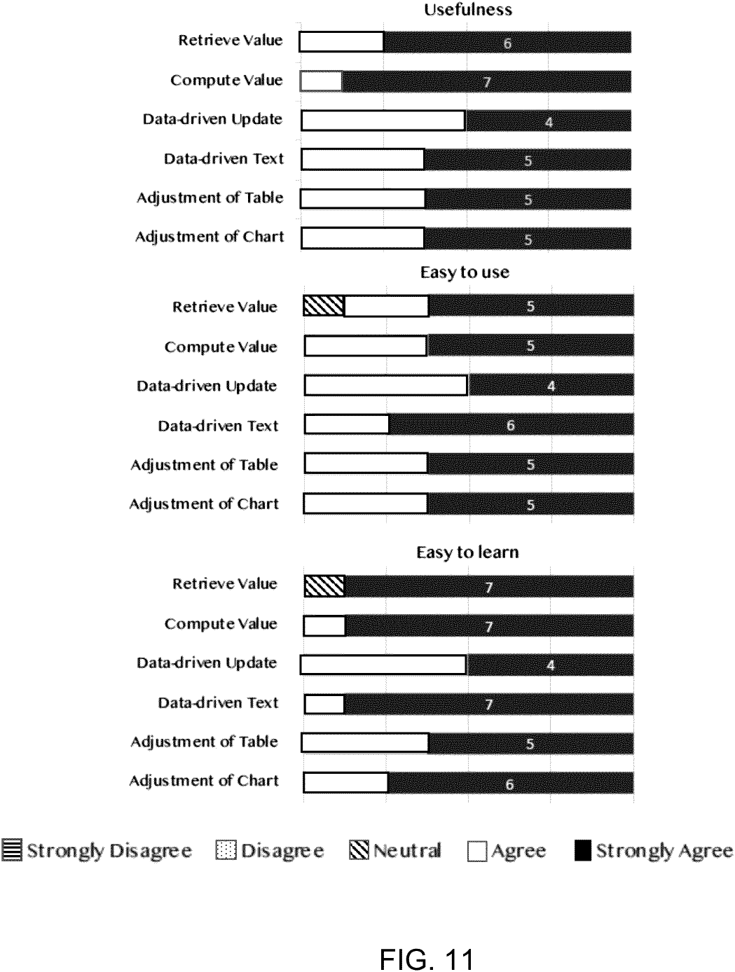

Utility of Text-Data Connections: Referring to FIG. 11, the interaction techniques provided by CrossData™ rated as useful by participants who confirmed that these techniques addressed key pain points in their daily work-flows and praised them as “killer features” for writing data documents. Among the various techniques, participants appreciated the compute value (7/8 strongly agree, 1/8 agree) and retrieve value (6/8 strongly agree, 2/8 agree) techniques as they facilitated the inputting of data by “enable[ing] computation using words”, “reduc[ing] application switching”, and “avoid[ing] typos.” One commenter noted that these techniques addressed some “fundamental issues” and thus brought “fundamental improvements to the writing process.”

Participants also responded positively (4/8 strongly agree, 4/8 agree) to the techniques designed to maintain consistency between data and text. These techniques helped users “ensure consistency” with “fewer manual efforts”. One commenter offered that these techniques could help her company “reduce human resource costs on the review team”.

The interactive techniques that facilitated iteration via interaction with data-driven text (5/8 strongly agree, 3/8 agree) and the automatic adjustments of tables (5/8 strongly agree, 3/8 agree) and charts (5/8 strongly agree, 3/8 agree) were also praised by participants because these techniques could “significantly reduce working back-and-forth” and enabled participants to “rapidly refine the charts [and tables].” Several participants remarked that the interactivity of the text, as well as the real-time synchronization between text, table, and charts, made the authoring process “fun and engaging”, but also could assist in thought processes and inspire more ideas during writing as the user can “see what he is writing”.

Authoring Workflow vs Traditional Tools: All participants agreed that the interactions provided by CrossData™ would mesh well with their current workflows (4/8 strongly agree, 4/8 agree), e.g., “you just need to write as usual.”. They further commented that these interaction techniques did not require installing another application and could be easily integrated within existing tools by “installing [them as] a plugin to my Word”.

All participants found that the interaction techniques could streamline their workflows due to “less context switching” and allow for efficient iterations of a document. A commenter noted that she used to frequently switch between “Excel, Word, and sometimes the calculator” during the writing process, which was “stressful and distracting.” By integrating CrossData™ with the existing tools, the participant could “concentrate on her writing”, and “focus on the current writing without worrying about refining or updating other sentences.”

Another improvement to participants’ workflows that was mentioned was “facilitating the process of getting feedback from others.” Mainstream tools such as Word® and PowerPoint® present reports in a static manner and thus hinder authors from addressing or responding to others’ feedback immediately, whereas the features provided by CrossData™ “make it very useful to answer ad-hoc questions during the discussions that would normally require some follow up work, e.g., swap out regions, look at percentage changes between different time periods, etc.”

In terms of the negative impacts these techniques may have on their workflows, one person noted that “perhaps the only cost is to learn how to use [them]”. Specifically, “you need to understand the concepts and get familiar with, for example, placeholders”. Nevertheless, as reflected in the results shown in FIG. 11, all participants reported that the interaction techniques were easy to learn and easy to use, indicating that the downside of using them would be negligible.

Enabling New Workflows to Bridge the Gap between Data Exploration and Writing: While CrossData™ was designed to support the writing stage, the intertwined nature of exploration and writing inspired participants to imagine CrossData™ beyond the presented tasks. Several additional benefits were suggested that could be enabled by the language-oriented techniques to facilitate data analysis and exploration.

First, natural language allows expression of reusable high-level goals instead of performing transient low-level operations, thereby improving the efficiency of data exploration. One commenter noted that with the compute value technique provided by CrossData™, he could efficiently calculate a value by typing a sentence instead of having to “scroll up and down in a sheet and brush and re-brush the cells.” Moreover, he suggested that the exploration process could be easily reused for different data by copying and pasting the text, i.e., “I can write text to retrieve and calculate values, and then copy the text to another sheet to get new values ... this is impossible in Excel since I cannot copy my interactions on one sheet to another.”

Second, CrossData™ could facilitate active thinking during the exploration process. One participant found that the suggestion list and interactive operators inspired them to explore the data from new perspectives that had not been recognized previously. They remarked that the suggested text was similar to the query recommendations in search engines. Another commenter explained that sometimes they stopped data exploration because it required too many tedious operations with Excel, i.e., “exploration is a process of thinking rather operating the Excel. . . I will definitely explore more if only a few clicks or types are required.”

Third, language-oriented data exploration enabled users to “record their exploration process as [a] draft” and naturally “shift from data exploration to writing.” All participants confirmed that there was a gap between data exploration and presentation in their current workflow, which has been recognized in prior work as an important research direction to improve the workflow of data analysts. One commenter noted that these “two interconnected stages [i.e., data exploration and communication,] were usually separated in two disconnected applications.” With language-oriented interaction techniques, however, data exploration and data document authoring can be tightly integrated such that “exploring [the data] is drafting [the document] and vice versa.”

Several interesting behaviors were observed that reflected participants’ real-world writing practices that were not supported by the prototype system.

First, when the data operations were simple, participants tended to directly type the result, which could result in untracked connections. For example, when writing “The U.S. reports the most new cases in America”, one participant manually typed “The U.S.” instead of using the placeholder feature. This was because that the participant already knew the desired data, and inserting a placeholder required more effort. The result, however, was that “The U.S.” text would not be updated when the participant was asked to modify “America” to “Africa”, resulting in data inconsistency due to the missing connections. While the Connection Engine is currently designed to interactively recommend data phrases, to address this issue, it could be extended to detect and connect manually typed dependent phrases to ensure that all data phrases would be connected with the underlying dataset.

We also observed that some participants reported approximate numbers instead of exact data values, which caused undesired suggestions from the engine. For example, one participant wrote that “[Placeholder] countries in America report more than 10,000 ...” He wanted to connect “10,000” with the new cases column. However, because “10,000” is an approximate number that did not exist in the new cases column, the Connection Engine could not return suggestions because it relies on string and synonym matching to suggest independent phrases. The writer then struggled to connect the “10,000” with the new cases column. Such behavior was also observed in other participants. While participants altered the approximate numbers to exact values to create connections, this issue could be common in real-world scenarios. To address this, CrossData™ could be extended to allow users to manually insert their desired connections or support fuzzy data value matching when certain keys are present, such as “almost” and “more than”.

Third, the participants tended to write safe, simple sentences to ensure the connections would be created successfully during writing. Overall, the sentences were relatively simple and had similar structures to the sentences in the training and reproduction tasks. While this could be attributed to the limited time frame of the task, it is possible that participants faced a dilemma when guessing which written text the system could understand and use to establish connections. Such an issue has been recognized as a long-standing challenge for users of NLI systems. To address this issue, the system could provide alternative methods (e.g., interface actions) to allow users to manually create text-data connections instead of fully relying on the auto-extraction of connections from the text. Several participants confirmed this improvement would be useful and necessary in their interviews, indicating that “the system should enable users to create or modify the connections after the writing.”

Participants noted some limitations of the CrossData™ system and suggested some improvements. Similar to other interactive systems that employ NLP, CrossData™ can misinterpret users’ intentions for the reasons discussed above relating to failure case analyses and observed behavior (e.g., lack of context, unrecognized approximate numbers). While CrossData™ allows users to correct misdetections caused by predefined rules, it does not support the correction of errors caused by NLP techniques. All participants expressed their concern regarding this and understood that they could be mitigated by further advancements of NLP techniques, more intelligent connection recognition algorithms, and by including the ability to flexibly modify the suggested connections.

Participants also proposed improvements relating to extensibility and customizability. For example, CrossData™ could support customized operators and calculations or enable users to import domain-specific operators from online libraries. Also, CrossData™ should enable users to share their customized operators with others to facilitate collaborative editing. In addition, the system should enable users to “freeze” connections so that they could rephrase sentences without worrying about losing any connections.

Several participants also raised concerns about scalability. For instance, an auditor, who often needed to write data documents to synthesize findings from more than 50 datasets, noted that connecting a phrase to all underlying datasets could lead to too many possible connections. A potential solution to this could be to add a context-awareness mechanism to CrossData™ so that it could prune the search space based on one’s writing context, e.g., the surrounding sentences, tables, charts, and section titles.

The examples described herein are directed to the connection of text to tabular data, wherein each data item is represented as a row and its attributes are represented as columns. While tabular data is common in practice, it does not naturally contain information about the rich relationships that exist among data items arranged within graph-based or tree-based data structures. Using a similar approach to the table formats, connections can be formed between text and rich data structures. The data visualizations currently supported within CrossData™ are basic charts (e.g., line and bar charts), however, a similar approach can be extended to support customized, complex data visualizations. This requires the identification of mappings between the natural human language used in data documents and the domain-specific terms used during data analysis and visualization processes. To develop such mappings, existing data documents can be annotated to describe or contain various data structures and visualizations.

Expanding the scope of a “document” beyond its conventional definition, the act of creating a work of authorship can be extended to programming for data analysis and visualization. Beyond graphical user interface applications, programming is another commonly used modality for data analysis and visualization. For example, computational notebook applications, which enable users to write programs to analyze and visualize data, are becoming increasingly popular. A common practice when using computational notebooks is to write explanatory textual descriptions alongside a program’s code to facilitate documentation and collaboration. This presents an opportunity to extend the use of written text for data analysis and visualization. Thus, one future direction could be to integrate CrossData™ into computational notebooks, so that users can analyze and visualize data by writing descriptive and self-explanatory text without requiring programming skills.

While CrossData™ leverages text-data connections to support the authoring of static data documents, the resulting data documents were interactive, suggesting opportunities to create interactive documents without any programming. The CrossData™ system can be expanded to support the creation of data-driven diagrams and simulations. Similarly, other forms of dynamic and interactive presentations of data can be created with text-data connections, such as data videos and data animations. For example, the connections between text with tables and charts can be directly employed to insert animated changes in tables and charts that correspond with the narration of animation, videos, or slideshows.

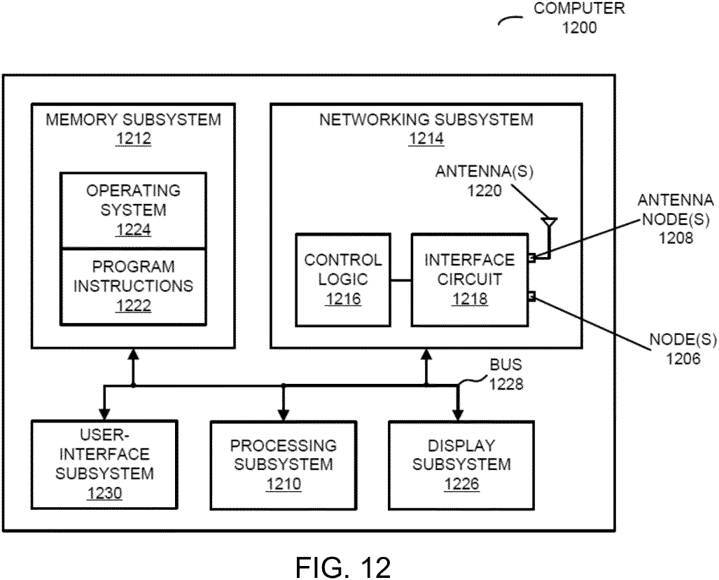

FIG. 12 presents a block diagram illustrating an exemplary computer architecture within a computer system suitable for implementation of the inventive CrossData™ approach. For example, a computer system may include one or more computers 1200. The computer 1200 may include processing subsystem 1210, memory subsystem 1212, and networking subsystem 1214. Processing subsystem 1210 includes one or more devices configured to perform computational operations. For example, processing subsystem 1210 can include one or more microprocessors, ASICs, microcontrollers, programmable-logic devices, GPUs and/or one or more DSPs. Note that a given component in processing subsystem 1210 may sometimes be referred to as a ‘computation device’.

Memory subsystem 1212 includes one or more devices for storing data and/or instructions for processing subsystem 1210 and networking subsystem 1214. For example, memory subsystem 1212 can include dynamic random access memory (DRAM), static random access memory (SRAM), and/or other types of memory. In some embodiments, instructions for processing subsystem 1210 in memory subsystem 1212 include: program instructions or sets of instructions (such as program instructions 1222 or operating system 1224), which may be executed by processing subsystem 1210. Note that one or more computer programs or program instructions may constitute a computer-program mechanism. Instructions in the various program instructions in memory subsystem 1212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1210.

In addition, memory subsystem 1212 can include mechanisms for controlling access to the memory. In some embodiments, memory subsystem 1212 includes a memory hierarchy that comprises one or more caches coupled to a memory in computer 1200. In some of these embodiments, one or more of the caches is located in processing subsystem 1210.

In some embodiments, memory subsystem 1212 is coupled to one or more high-capacity mass-storage devices (not shown). For example, memory subsystem 1212 can be coupled to a magnetic or optical drive, a solid-state drive, or another type of mass-storage device. In these embodiments, memory subsystem 1212 can be used by computer 1200 as fast-access storage for often-used data, while the mass-storage device is used to store less frequently used data.

Networking subsystem 1214 includes one or more devices configured to couple to and communicate on a wired and/or wireless network (i.e., to perform network operations), including: control logic 1216, an interface circuit 1218 and one or more antennas 1220 (or antenna elements). (While FIG. 12 includes one or more antennas 1220, in some embodiments computer 1200 includes one or more nodes, such as antenna nodes 1208, e.g., a metal pad or a connector, which can be coupled to the one or more antennas 1220, or nodes 1206, which can be coupled to a wired or optical connection or link. Thus, computer 1200 may or may not include the antennas 1220. Note that the one or more nodes 1206 and/or antenna nodes 1208 may constitute input(s) to and/or output(s) from computer 1200.) For example, networking subsystem 1214 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 1214 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Computer 1200 may use the mechanisms in networking subsystem 1214 for performing simple wireless communication between electronic devices, e.g., transmitting advertising or beacon frames and/or scanning for advertising frames transmitted by other electronic devices.

Within computer 1200, processing subsystem 1210, memory subsystem 1212, and networking subsystem 1214 are coupled together using bus 1228. Bus 1228 may include an electrical, optical, and/or electro-optical connection that the subsystems can use to communicate commands and data among one another. Although only one bus 1228 is shown for clarity, different embodiments can include a different number or configuration of electrical, optical, and/or electro-optical connections among the subsystems.

In some embodiments, computer 1200 includes a display subsystem 1226 for displaying information on a display, which may include a display driver and the display, such as a liquid-crystal display, a multi-touch touchscreen, etc. Further, computer 1200 may include a user-interface subsystem 1230, such as: a mouse, a keyboard, a trackpad, a stylus, a voice-recognition interface, and/or another human-machine interface.

Computer 1200 can be (or can be included in) any electronic device with at least one network interface. For example, computer 1200 can be (or can be included in): a desktop computer, a laptop computer, a subnotebook/netbook, a server, a supercomputer, a tablet computer, a smartphone, a cellular telephone, a consumer-electronic device, a portable computing device, communication equipment, and/or another electronic device.

Although specific components are used to describe computer 1200, in alternative embodiments, different components and/or subsystems may be present in computer 1200. For example, computer 1200 may include one or more additional processing subsystems, memory subsystems, networking subsystems, and/or display subsystems. Additionally, one or more of the subsystems may not be present in computer 1200. In some embodiments, computer 1200 may include one or more additional subsystems that are not shown in FIG. 12. Also, although separate subsystems are shown in FIG. 12, in some embodiments some or all of a given subsystem or component can be integrated into one or more of the other subsystems or component(s) in computer 1200. For example, in some embodiments program instructions 1222 are included in operating system 1224 and/or control logic 1216 is included in interface circuit 1218.

The foregoing description is intended to enable any person skilled in the art to make and use the disclosure and is provided in the context of a particular application and its requirements. Further, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown but is to be accorded the widest scope consistent with the principles and features disclosed herein.

1. A method for managing workflows for authoring data documents, wherein one or more dataset is retrieved from a data source, the method comprising:
using a computing device to:
receive a text string within a data document being generated by at least one writer;
execute a connection engine configured to perform natural language processing (NLP) to:
extract from within the text string words and phrases having keywords corresponding to data operations within a predefined operation dictionary;
parse the text string into a plurality of nested nodes comprising sub-phrases comprising independent data phrases and keywords;
assemble the independent data phrases and data operations in one or more node of the plurality of nested nodes into one or more complete data operation; and
execute the one or more complete data operation and return matching results from the one or more dataset as one or more dependent phrase candidate to complete the text string;
prompt the at least one writer to select a selected candidate from the one or more dependent phrase candidates; and
create a persistent text-data connection between the selected candidate and the one or more dataset;
wherein the persistent text-data connection is configured to automatically update the selected candidate when one or a combination of the one or more dataset, the independent data phrases, and the keywords is modified by the writer.

2. The method of claim 1, wherein the data operations comprise one or a combination of Retrieve Value, Filter, Find Extremum, Compute Derived Value, Determine Range, Find Anomalies, and Compare.

3. The method of claim 1, wherein the data operations have arguments comprising one or more independent data phrases or an output of another data operation.

4. The method of claim 1, wherein the one or more dataset comprises a table, wherein the independent data phrases and the output are a row, a column, or a value in the table.

5. The method of claim 4, wherein the connection engine is further configured to update the table to add a new row or a new column in response to computation of a dependent phrase.

6. The method of claim 4, wherein the table is embedded within the data document.

7. The method of claim 1, wherein the dependent data phrase comprises an output of one or more computation by the data operations, the output comprising a derived value that does not exist in the dataset.

8. The method of claim 1, wherein the one or more dataset comprises a chart embedded within the data document.

9. The method of claim 1, wherein the step of parsing the text string uses a context-free grammar, wherein a structure of the plurality of nested nodes is independent of a context of the text string.

10. The method of claim 1, where the connection engine is further configured to generate potential independent phrases within an incomplete text string by performing string matching with all strings in the dataset and synonym matching with all attribute names in the dataset.

11. A computer system, comprising:
a computing device;
memory configured to store program instructions, wherein, when executed by the computing device, the program instructions cause the computer system to perform one or more operations comprising:
receiving a text string within a data document being generated by at least one writer;
executing a connection engine configured to perform natural language processing (NLP) to:
extract from within the text string words and phrases having keywords corresponding to data operations within a predefined operation dictionary;
parse the text string into a plurality of nested nodes comprising sub-phrases comprising independent data phrases and keywords;
assemble the independent data phrases and data operations in one or more node of the plurality of nested nodes into one or more complete data operation; and
execute the one or more complete data operation and return matching results from the one or more dataset as one or more dependent phrase candidate to complete the text string;
prompt the at least one writer to select a selected candidate from the one or more dependent phrase candidates; and
create a persistent text-data connection between the selected candidate and the one or more dataset;
wherein the persistent text-data connection is configured to automatically update the selected candidate when one or a combination of the one or more dataset, the independent data phrases, and the keywords is modified by the writer.

12. The computer system of claim 11, wherein the data operations comprise one or a combination of Retrieve Value, Filter, Find Extremum, Compute Derived Value, Determine Range, Find Anomalies, and Compare.

13. The computer system of claim 11, wherein the data operations have arguments comprising one or more independent data phrases or an output of another data operation.

14. The computer system of claim 11, wherein the one or more dataset comprises a table, wherein the independent data phrases and the output are a row, a column, or a value in the table.

15. The computer system of claim 14, wherein the connection engine is further configured to update the table to add a new row or a new column in response to computation of a dependent phrase.

16. The computer system of claim 14, wherein the table is embedded within the data document.

17. The computer system of claim 11, wherein the dependent data phrase comprises an output of one or more computation by the data operations, the output comprising a derived value that does not exist in the dataset.

18. The computer system of claim 11, wherein the one or more dataset comprises a chart embedded within the data document.

19. The computer system of claim 11, wherein the step of parsing the text string uses a context-free grammar, wherein a structure of the plurality of nested nodes is independent of a context of the text string.

20. The computer system of claim 10, where the connection engine is further configured to generate potential independent phrases within an incomplete text string by performing string matching with all strings in the dataset and synonym matching with all attribute names in the dataset.
